(19) United States
(12) Patent Application Publication
(10) Pub. No.: US 2010/0267902 A1
(43) Pub. Date: Oct. 21, 2010

(54) Process

(75) Inventors: Dongyu Cai, Leicestershire (GB); Jie Jin, Leicestershire (GB); Mo Song, Leicestershire (GB)

Correspondence Address: Tod T. Tumey, P.O. BOX 22188, HOUSTON, TX, 77227-2188, US

(73) Assignee: LOUGHBOROUGH UNIVERSITY, Leicestershire (GB)

(21) Appl. No.: 12/678,152

(22) PCT Filed: Sep. 15, 2008
(86) PCT No.: PCT/GB2008/003130

§ 371 Date: Jun. 14, 2010

(30) Foreign Application Priority Data
Sep. 14, 2007 (GB) 0717937.7
Apr. 30, 2008 (GB) 0807857.8

(51) Int. Cl. C08F 10/06; C08F 114/06; C08G 63/08; C08F 120/10; C08F 112/08

(52) U.S. Cl. 525/331.5; 525/50; 525/333.7; 525/415; 525/330.3; 525/333.3

(57) ABSTRACT

The present invention provides a process for producing a treated or modified polymer, which process comprises the steps of: (I) providing a mixture comprising a liquid, an additive and a polymer, wherein the additive is dispersed in the liquid; and (II) heating the mixture obtained in step (I) to soften the surface of the polymer so that the additive attaches to the polymer.

The present invention relates to a process for producing modified or treated polymer.

It is often desirable to modify polymers in order to impart advantageous properties to articles made from the polymers or from compositions comprising the polymers. Polymer compositions often comprise fillers or additives to modify the mechanical properties of polymer or to reduce costs. For example, polymers are typically electrically insulating and, in some circumstances, it can be desirable to treat a polymer to provide a modified polymer which is electrically conductive.

Conventionally, the production of filled polymers has been a two step process in which an additive, commonly known as a filler, is mixed with a polymer or polymer resin, and the mixture is then melted and extruded. The extrudate is then chopped into beads that are then re-melted and extruded or moulded as required to produce the finished product.

Conventional methods such as the one described above can often lead to aggregation of the filler and other problems, which can result in the modified polymer having impaired mechanical properties compared to those of the virgin polymer. Other problems are known in the art such as the need to “over-dose” pigments in order to obtain a required colour or opacity.

The listing and discussion of an apparently prior-published document in this specification should not necessarily be taken as an acknowledgement that the document is part of the state of the art or is common general knowledge.

It is an object of the present invention to provide an alternative method for modifying, treating or filling polymers. It is also an object of the present invention to address one or more of the problems mentioned above.

The present invention provides a process for producing a treated or modified polymer, which process comprises the steps of:
(I) providing a mixture comprising a liquid, an additive and a polymer, wherein the additive is dispersed in the liquid;
(II) heating the mixture obtained in step (I) to soften the surface of the polymer so that the additive attaches to the polymer.

Step (I) may comprise the steps:

(i) mixing an additive and a liquid;
(ii) dispersing the additive in the liquid;
(iii) providing a mixture comprising the product of step (ii) and a polymer;

Step (iii) may comprise adding the polymer into the mixture produced in step (ii) or adding the mixture produced in step (ii) to the polymer. The polymer may be neat or in a liquid.

Alternatively, step (I) may comprise the steps of:

(a) adding the polymer and the additive to the liquid; and
(b) dispersing the additive in the liquid.

In step (a) the polymer and the additive may be added to the liquid simultaneously or sequentially.

For the avoidance of doubt, in the process of the invention the additive is not removed from the liquid after step (I) and before step (II) i.e. it is not removed from the liquid after step (ii) or step (b).

As used herein, the term “additive” is used to refer to any material which can adhere to the softened polymer and thereby alter the properties of the polymer. The additive is typically stable under the heat and pressure conditions that are used to soften the polymer (ie it does not degrade under these conditions or does not undergo alteration under those conditions). However, it is also envisaged that “precursor additives” could be used. By this we mean that an additive which is altered or reacts or degrades under the conditions used in the process of the invention to generate an additive which has desired properties may be used. The additive (or the precursor additive and the additive in generates) must not react in a deleterious manner with the polymer under the conditions used in the process of the invention and nor ideally under the conditions or in the environment in which the modified polymer is used.

Suitable additives are well known in the art and are often referred to in the art as fillers. Any suitable additive or filler may be used. Examples of suitable additives include, but are not limited to, inorganic particulates and organic particulates. By “particulates” we mean solid materials which do not dissolve in the liquid.

Suitable additives include, but are not limited to, conventional reinforcing materials and fillers.

Examples of suitable inorganic particulates include, but are not limited to, carbon black, graphite, expanded graphite, graphite oxide, carbon fibers, for example short carbon fibres, boron fibers, carbon nanotubes, metal particles, for example copper or aluminum particles, metal oxide particles such as transition metal oxides, for example TiO₂ or alkali earth metal oxides, for example MgO₂, MgO, short or long glass fibres, natural montmorillonite, organically modified montmorillonite, clays, zeolites, analcime, chabazite, heulandite, natrolite, phillipsite, stilbite and mica flakes, mineral fillers or ceramic particles or fibres, for example silica.

Examples of organic containing particulates include, but are not limited to, organic dyes and organic photochromics.

Suitable additives may also be categorized in terms of their function. For example, additives selected from the following classes of additive may be used UV stabilizers, antioxidants, pigments, dyes, nucleating agents, crystallization accelerators, flame retardants, impact modifiers, conducting additives, anti-fogging agents, optical brighteners, fragrances, fungicides, oxidation retardants, light stabilizers, heat stabilizers, flow promoters, lubricants and mould release agents and additives that modify the surface energy of the polymer, eg change its wetting properties.

Suitable additives also include inert materials such as chalk or talc. By inert materials we include materials which do not impart specific properties to the modified polymer. Such additives can be considered to be bulking agents. Such inert additives and bulking agents can be used alone or in combination with other additives.

As will be appreciated from the listed examples of suitable additives, the additive can be electrically conductive, semi-conducting or insulating. By electrically conductive we mean that the additive has a conductivity of greater than about 10⁻¹ S/cm. By semi-conducting we mean that the additive has a conductivity of from about 10⁻⁹ S/cm to about 10⁻¹ S/cm. By electrically insulating we mean that the additive has a conductivity of less than about 10⁻⁹ S/cm. For the avoidance of doubt, these electronically conductivity values are values that would be obtained at room temperature (about 20° C.).

It is not essential that the additive is wholly in particulate form after it has been added to and dispersed in the liquid in step (I), more particularly in steps (i) and (ii) or steps (a) and (b) of the process of the invention. Additives which wholly or partially dissolve in the liquid, for example photochromic dyes or common salt (NaCl) can be used.

In a preferred aspect of the invention the additive is in particulate form after it has been added to and dispersed in the liquid. In other words, the additive is not soluble in the liquid and the additive is dispersed in the liquid in the form of a suspension.

If the additive dissolves in the liquid it is not essential that it fully dissolves, ie the liquid may be saturated with the additive and the liquid may also contain suspended additive particles. Typically, if a soluble additive is used it is present in the liquid, after step (ii) at a level at or below its saturation point in the liquid.

Combinations of additives can be used, ie one or more additives can be used. When more that one additive is used the combination of additives and their ratios can be selected to optimize the properties of the modified polymer.

When two or more additives are used they can be added to the liquid in step (i) simultaneously or sequentially before step (ii) is conducted. Alternatively, steps (i) and (ii) can be performed with one additive and then repeated to introduce one or more additional additives.

If steps (a) and (b) are used and two or more additives are used they can be added to the liquid in step (a) simultaneously or sequentially before step (b) is conducted. Alternatively, steps (a) and (b) can be performed with one additive and then repeated to introduce one or more additional additives. In this situation, the polymer may be introduced in just one of the steps (a) or some of the polymer may be introduced in each of the steps (a).

The particle size of the additive is not particularly limited. Preferably, the additive particles have a mean diameter which is up to about 20% of the mean diameter of the polymer particles, more preferably from about 10 to about 15% of the mean diameter of the polymer particles. The invention is particularly suitable for use with nano size additive particle, although larger size additive particles may also be used.

Any suitable liquid may be used in the process. Suitable liquids do not react with or cause deleterious degradation of the polymer or the additive(s) under the conditions used in the process and remain liquid at a temperature and pressure suitable to soften the polymer.

Typically the liquid is a liquid in which the polymer does not dissolve.

Liquids suitable for use in the process of the invention are typically liquids which can relatively easily be removed from the reaction mixture to leave a dry modified polymer after the use of standard techniques for removing liquids from solids such as filtration, evaporation and/or air drying. Particularly suitable liquids are those with a boiling point of 200° C. or less, more preferably 150° C. or less and most preferably 110° C. or less.

The liquid may be an organic liquid, which may be polar or non-polar. Suitable organic liquids include, but are not limited to toluene, N, N-dimethylformamide and chloroform.

Aqueous liquids may be used. Water may be used as the liquid. It is not necessary to use distilled water in the process of the invention, although it may be used. Tap water (for example drinking water) may be used.

A preferred liquid for use in the process of the invention is water.

The weight ratio of the additive to the liquid can vary within wide limits. However, when the additive is not soluble in the liquid it is important the weight ratio of the additive to the liquid is suitable for the formation of a suspension of the additive in the liquid. For the formation of a suspension, the weight of the additive as a percentage of the total weight of the additive and the liquid is typically from about 0.05 or about 0.1 to about 50 wt %, more preferably from about 0.5 or about 1 to about 30 wt % and more preferably from about 0.8 to about 20 wt % for example about 9 wt % to about 10 wt %, for example about 1 wt %, about 2 wt %, about 3 wt %, about 4 wt % or about 5 wt %. Weight ratios within these ranges are also suitable when the additive does (at least partly) dissolve in the liquid, although it will be appreciated that in this situation the most suitable weight ratio may depend on factors such the solubility of the additive.

The combination of the additive and the liquid may have any consistency suitable for the dispersion means to be used. For example, when sonication is used for dispersion the combination of the liquid and the additive may have the consistency of a slurry, alternatively a lower concentration of additive in the liquid may be used.

It will be appreciated that the amount of additive used in a particular process will depend on a number of factors including the size of the additive particles. Typically, the amount, in terms of weight, of the additive particles required will be lower if the mean diameter of the additive particles is lower.

It will also be appreciated that additional liquid may be required to submerse the polymer in the liquid. The amount of additional liquid required (if any) required will depend on numerous factors such as the volume of polymer used.

Any suitable method can be used to disperse the additive in the liquid in step (I), more particularly in step (ii) or (b). Suitable methods include, but are not limited to, stirring, shaking and ultrasonic dispersion and combinations thereof. A preferred method is ultrasonic dispersion. For example, ultrasonic dispersion may comprise subjecting the mixture obtained in step (i) to ultrasonic agitation in step (ii).

Ultrasonic dispersion is particularly suitable when nano size additive particles are used.

Step (I), for example step (ii) or step (b), can be conducted at any suitable temperature. Typically, suitable temperatures are from about 15 to about 250° C., e.g. about 160° C.

For example, this step may be conducted at ambient temperature or at room temperature (about 20° C.).

Step (I), for example (ii) or step (b) can be conducted at any suitable pressure. Typically this step is conducted at atmospheric (about 1.013×10⁵N/m²) or ambient pressure. However, higher pressure may be used, for example pressures up to about 3 atmospheres (about 3.039×10⁵N/m²) may be used.

One purpose of step (I), for example step (ii) or step (b) is to prevent agglomeration of the additive particles. Following introduction of a particulate additive into the liquid, there is often a tendency for the additive to form agglomerates due to the interactions between the individual particles. It is, therefore, an object of step (I), for example step (ii) or step (b) to disperse a particulate additive substantially uniformly throughout the liquid and reduce agglomeration or even substantially eliminate agglomeration.

The person of ordinary skill in the art will be able to readily determine whether a particulate additive is sufficiently uniformally dispersed throughout the liquid and whether agglomeration has been sufficiently reduced. For example, a person experienced in the art of sonication will know parameters to use to ensure adequate separation of clusters of particles. Known methods to analyse particle size in suspension may be used to confirm that additive particles are uniformally dispersed and/or that agglomeration has been reduced.

It is preferable that the mixture obtained in step (I) i.e. in step (ii) or step (b) is a substantially homogenous or substantially uniform mixture of the additive in the liquid.

In some instances, for example where the interactions between the liquid and the particulate additive are substantially weaker than the inter-particle interactions or other instances where the formation of agglomerates is more likely, it may be necessary to reduce or prevent the formation of agglomerates by chemical means.

If necessary, one or more surfactants can be used to facilitate the dispersion of the additive in the liquid. The nature of any surfactant used will depend on the additive and the liquid. Suitable surfactants include, but are not limited to ionic and non-ionic surfactants. Suitable non-ionic surfactants include, but are not limited to, polyisobutylene, polydimethylsiloxane and co-polymers of dimethylsiloxane and vinyl acetate.

When a surfactant is used it may be added to the mixture simultaneously or sequentially with the other components in step (I). For example, the surfactant may be added before or during step (ii) or during or after step (a).

Methods in which the ionic strength or pH are modified may alternatively or additionally be used to disperse additive particles and/or reduce agglomeration.

Any thermoplastic polymer can be used in the process of the present invention. The term “thermoplastic” is widely used and readily understood in the art and is used to refer to materials that becomes soft, moldable and weldable when heated. Typically thermoplastic materials can be repeatedly softened by heat and cooled without any appreciable change in properties.

Polymers derived from a single monomer and co-polymers may be used in the process of the invention as may polymer blends.

Examples of thermoplastics that may be used in the present invention include, but are not limited to, Acrylonitrile butadiene styrene (ABS), Acrylic, Celluloid, Cellulose acetate, Ethylene-Vinyl Acetate (EVA), Ethylene vinyl alcohol (EVAL), Fluoroplastics (PTFEs), including FEP, PFA, CTFE, ECTFE, ETFE), Ionomers, Kydex, a trademarked acrylic/PVC alloy, Liquid Crystal Polymer (LCP), Polyacetal (POM or Acetal), Polyacrylates (Acrylic), Polyacrylonitrile (PAN or Acrylonitrile), Polyamide (PA or Nylon), Polyamide-imide (PAI), Polyaryletherketone (PAEK or Ketone), Polybutadiene (PBD), Polybutylene terephthalate (PBT), Polychlorotrifluoroethylene (PCTFE), Polyethylene terephthalate (PET), Polycyclohexylene dimethylene terephthalate (PCT), Polycarbonate (PC), Polyhydroxyalkanoates (PHAs), Polyketone (PK), Polyester, co-polyesters, polyolefins such as Polyethylene (PE), Polypropylene (PP), Polybutylene (PB), Polymethylpentene (PMP), and olefin based co-polymers, Polyetheretherketone (PEEK), Polyetherimide (PEI), Polyethersulfone (PES), Polyethylenechlorinates (PEC), Polyimide (PI), Polylactic acid (PLA), Polyphenylene oxide (PPO), Polyphenylene sulfide (PPS), Polyphthalamide (PPA), Polystyrene (PS), Polysulfone (PSU), Polyvinyl chloride (PVC), Polyvinylidene chloride (PVDC), Spectralon, plasticised starches, polyhydroxybutyrate (PHB) and polyvinyl alcohol (PVA or PVOH).

Preferred polymers for use in the invention include nylons, polyethylene, polypropylene, polystyrene, block copolymer, poly(methyl methacrylate), poly(vinyl chloride), poly(vinyl acetate), polycarbonate, polycaprolactone, poly(ethylene oxide), poly(vinyl alcohol), Chitosan, poly(ethylene terephthalate), poly(ether sulfone), Poly(butyl terephthalate), pol(ethyl methacrylate), ultra high molecular weight polyethylene. Particularly preferred polymers include nylons, polyvinyl chlorides, polycaprolactones, styrene-vinyl acetate diblock copolymers, polyolefins such as polypropylenes, polyethylenes, olefin based co-polymers.

The present invention is particularly suitable for modifying polymers which are solid at ambient temperature (for example, polymers which have a glass transition temperature and/or melting point of greater than about 30° C.). Unless otherwise stated, in this specification a reference to “the polymer” or “a polymer” should be understood to encompass polymers which are solid at ambient temperature. The polymer is preferably used in powder or particulate form, for example as a powder or in the form of pellets or granules. However, this is not essential. If the polymer is melted during step (II) (ie the polymer is heated to a temperature at or above its melting point) it may not be necessary to use a polymer which is a powder or particulate form. Additionally, pre-formed or finished polymers may be used in the process of the invention. Typically, when pre-formed or finished polymers are used, the process of the invention is used to modify the surface properties of the polymers or to provide a coating on all or part of the surface of the preformed or finished polymer.

It will be appreciated that throughout this specification when the term “polymer” in used in relation to process of the invention this term can be replaced by “polymer powder” or “polymer particles” as the use of the polymer in these forms is a preferred aspect of the invention.

By the term “pre-formed polymer” we mean a part formed product which needs further processing in order to become a finished product. By the term “finished polymer” we mean a finished article made from a polymer.

The molecular weight of the polymers used in the invention is not critical and can vary within wide limits. As a non-limiting example, the present invention is suitable for use with polymers having a molecular weight of from about 10³ to about 10⁶. Although polymer having molecular weights outside this range may also be used.

When a polymer powder is used, the size of the polymer particles can vary within a wide range, for example from about 1 nm to about 5 cm, more preferably from about 10 nm to about 2 cm, more preferably from about 30 nm to about 1 cm, for example from about 60 μm to about 1 cm.

The polymer powder may be amorphous, semi-crystalline or crystalline before it is heated.

The process of the present invention is applicable to individual polymers and mixtures of polymers. For example, a polymer powder containing a single polymer may be used. Alternatively, a polymer powder containing polymers of the same composition but different molecular weights may be used. Alternatively, the polymer powder may contain two or more polymers which are chemically different. If two or more polymers are used, they must be selected so that they do not react with one another under the conditions used in the process of the invention.

It is envisaged that the process of the invention can be used to introduce an additive into a polymer which already comprises a filler or additive. However, It is preferable that the polymer used in the process of the invention is a neat or virgin polymer or a blend of neat or virgin polymers. By this we mean that it is preferable that the polymer or blend has not been modified by the introduction of an additive or a filler before it is subjected to the process of the invention. In particular, it is preferred that the polymer or blend used in the process of the invention does not contain carbon black before it is subjected to any of the steps of the process of the invention. In this regard, if it is desired to produce a modified polymer containing two additives, for example carbon black and another additive, it is preferred to introduce both of these additives to the polymer or blend using the process of the invention. In this situation, the steps of the process of the invention may be used to introduce one additive and then repeated (as necessary) to introduce further additives. Alternatively all of the additives may be introduced together.

In step (iii), if the polymer is added to the product of step (ii), the whole of the polymer can be introduced in a single addition or the polymer can be introduced gradually. Likewise, if the product of step (ii) is added to the polymer the whole of the product of step (ii) can be added in a single addition or introduced gradually.

The polymer may be added to the mixture obtained in step (ii) neat or it may be suspended in a liquid (preferably the same liquid as used in step (i)) before it is added to the mixture obtained in step (ii).

In step (II) the mixture obtained in step (I) is heated to soften the polymer. It is typically not critical whether the polymer is heated slowly or rapidly. This means that if in step (ii) the mixture of the liquid and the additive has been heated to aid dispersion, in step (iii) the polymer can be combined with the already heated mixture or the mixture of step (ii) can be heated prior to step (iii).

Preferably, in step (iii) and step (b) the polymer is dispersed in the mixture. This can be done using any suitable method known in the art such as stirring or shaking and combinations thereof. Most preferably, a substantially homogenous dispersion of the polymer within the liquid is achieved.

Step (iii) and step (b) can be conducted at any suitable temperature. Typically, suitable temperatures are from about 15° C. to about 250° C., or to about 160° C. Step (iii) can also be carried out at (or even below) ambient temperature. For example, this step may be conducted at ambient temperature or at room temperature (about 20° C.).

The weight ratio of the polymer to the additive in the mixture produced in step (I) will depend at least in part on the nature of the polymer and the additive and also on factors such as the desired properties for the modified polymer. Thus the weight ratio of the polymer to the additive may vary within wide limits. As an example, the weight ratio polymer:additive may be from about 80:20 to about 99.99:0.01, preferably from about 85:15 to about 99.9:0.1, more preferably from about 90:10 to about 99:1, for example about 91:9, 92:8, 93:7, 94; 6, 95:5, 96:4, 97:3 or 98:2.

In step (II) the mixture is allowed to reach a temperature at which the polymer surface softens and maintained at that temperature for a period of time sufficient for the additive to adhere to the softened polymer. Typically, this means that the mixture obtained in step (I) is heated to a suitable temperature and then maintained at that temperature. Alternatively, the mixture can be maintained at the temperature used in step (I), if this is sufficient to soften the polymer.

In step (II) the surface of the polymer, for example the surface of the polymer particle or pellet or granule, is softened. Alternatively, it could be said that the surface of the polymer (or polymer powder particles) melts. The softening or melting occurs to a degree suitable to enable the additive to attach to the polymer.

Melting of the surface of the polymer particles must be distinguished from complete melting of the polymer particles. When only the surface of the polymer particles is melted the polymer particles remain as discreet particles. When the polymer is completely melted the polymer becomes liquid and discreet particles are no longer present. It is preferred but not essential that the polymer particles remain as discreet particles, ie the surface of the polymer particles softens or melts.

It is not always necessary to carefully control the temperature to which the mixture is heated. Whether or not this is necessary depends on a number of factors such as the nature of the polymer, the nature of the additive and the intended properties of the resulting modified polymer. Sometimes the temperature used in step (iv) must be carefully controlled. For example, for some applications it is important to ensure that the polymer softens but does not melt, ie it is necessary to ensure that polymer particles stay as discreet particles. This is often important when a conductive additive is being used.

In step (II), the mixture is heated a temperature which is typically from about 10° C. below the melting point of the polymer to about 10° C. above the melting point of the polymer.

In situations in which melting of the polymer is not desired, heating is controlled so that the maximum temperature reached is less than the melting point of the polymer, for example from about 0.1° C. to about 10° C. below the melting point of the polymer, more preferably from about 2° C. to about 8° C. below the melting point of the polymer, for example about 5° C. below the melting point of the polymer.

For other applications, it is not important whether or not the polymer melts as long as it is at least softened. For these applications the heating temperature does not need to be so closely controlled. However, it is preferable that a temperature no more that about 10° C., more preferably no more than about 5° C. above the melting point of the polymer is reached.

Typically, a temperature of from about 20° C. to about 300° C., more preferably from about 50° C. to about 250° C., for example from about 70° C. to about 200° C. or from about 100° C. to about 150° C. is used in step (II). It will however be appreciated that for certain polymers such as Kevlar higher temperatures may be required, for Kevlar this would be in the order of 500° C.

Once the temperature required for step (II) has been reached, that temperature is maintained for a length of time sufficient for additive to adhere to the surface of the polymer particles. The length of time of this step will depend on factors such as the concentration of the additive in the liquid and the desired properties of the modified polymer particles. Any length of time from about 30 seconds to several hours may be used, typically from about 1 minute to about 1 hour, preferably from about 2 minutes to about 30 minutes, more preferably from about 5 minutes to about 20 minutes, for example about 10 minutes or about 15 minutes.

Typically the mixture is agitated during step (II). Any suitable method known in the art may be used. Suitable methods include, but are not limited to, stirring, shaking and combinations thereof. Typically, high shear techniques are not used during step (II), ie low shear techniques are used. Stirring at rates below 80 rpm is preferred, more preferably below 50 rpm.

Step (II) can be carried out at atmospheric pressure or at a higher pressure. Typically a pressure of from about 1 atmosphere to about 100 atmospheres, for example from about 2 atmospheres to about 90 atmospheres or from about 3 atmospheres to about 50 atmospheres is used. The pressure is selected so that the liquid can be heated to the temperature required to soften the polymer. For example, water can be heated to 250° C. at 1.8 atmospheres.

The properties of the modified polymer particles produced in the process of the invention can be controlled by control of the process conditions (ie the time and/or temperature used in step (II)). For example, increasing the time period for which step (II) is carried out can increase the amount of additive which adheres to the polymer.

In step (II) the dispersed additive adheres to the softened polymer.

Without wishing to be bound by theory, it is believed that there is no chemical reaction between the polymer and the additive. Rather, it is thought that the additive becomes physically embedded in or trapped on the surface of the softened polymer. It is thought that eventual cooling of modified polymer binds the additive to the surface of the polymer more strongly, ie in the modified polymers produced using the process of the invention the additive is attached to or adhered to the surface of the polymer.

The process of the present invention may additionally comprise any steps necessary to make the modified polymer suitable for further processing.

It is possible that the modified polymer suspended in the liquid used in the process of the invention could be further processed in that form. However, it is envisaged that for many applications the modified polymer will be recovered from the reaction mixture before further processing is carried out. Thus, after step (II) the modified polymer is typically recovered from the reaction mixture.

The modified polymer can be removed from the liquid by any method known in the art for removing solids from a liquid in which they are suspended, such as filtration (eg membrane filtration) or centrifugation. The liquid may be cooled before the modified polymer is removed but this is not essential.

If the mixture is cooled before the polymer particles are removed, the liquid may be cooled slowly (eg the heat source is removed and the liquid is allowed to reach to ambient temperature) or cooling may be done rapidly (eg plunging the container into an ice bath or dry ice bath). Optionally, the mixture may be agitated (for example, by stirring or shaking) during the cooling step.

If the liquid is cooled, it is typically cooled to a temperature of from about 15° C. to about 100° C., for example from about 30° C. to about 50° C.

Processes in which the liquid is removed, recycled and reused without complete cooling are also envisaged.

Drying of the modified polymer is usually required, particularly when water is used as the liquid in the process of the invention. Complete removal of water is usually necessary before the polymer particles can be processed further. Suitable methods of drying include standard methods known in the art, such as warm air drying.

If the polymer is allowed to melt in step (II), an agglomerate of the modified polymer may be formed when the polymer is cooled. In this situation, further processing, such as milling of the polymer to form polymer particles may be required before the modified polymer can be used.

Typically, if in step (II) the polymer is softened but not melted the polymer remains as discrete particles (assuming of course that the polymer was in the form of particles are step (I)).

The modified polymer particles produced using the method of the invention can be used and processed in ways well known it the art. For example, they can be processed using techniques such as injection molding, extrusion, vacuum forming, blow molding, rotational molding, powder coating and film forming.

Without wishing to be bound by theory, it is thought that the process of the present invention can provide one or more of the following advantages.

Known methods for modifying polymers often involve the use of high shear mixing (ie process in which mixing at a rate of more than 80 rpm is required. Such high shear mixing is not required in the present invention because good levels of dispersion of the additive and/or the polymer are obtained in the process of the present invention (ie the additive and/or the polymer is substantially homogeneously dispersed in the liquid).

It should also be noted that high shear mixing is preferably avoided in step (I) of the invention. If mixing is required low shear mixing as defined above is used in step (I) e.g. in steps (ii) and/or (iii) or step (b).

When the polymer powder is softened (rather than melted), the size and geometry of the polymer powder particles is substantially maintained, facilitating subsequent fabrication of components using the treated polymer.

It has been found that the process of the invention can provide more efficient/effective addition of the additive to the polymer. This means that less additive is often required compared to some conventional processes and/or a lower concentration of additive in the liquid is required to produce the same product and/or lower levels of adhesion of the additive to the polymer are required to give the same technical effect.

The properties of the modified polymers are often optimized because the additive is more evenly distributed over the surface of the polymer particles than in conventional techniques.

Preliminary experiments have shown that using the process of the invention polypropylene can be modified to provide the same level of conductance achieved using methods of the prior art but using only about one twentieth of the quantity (by volume %) of electrically conductive additive (such as graphite or carbon black) using conventional processing methods, such as the two-stage processing method discussed in the background section of this specification.

The use of the process of the present invention typically results in minimal degradation of the mechanical properties of the treated polymer powder, which means that the treated polymer can typically be processed more readily. Further advantages flow from this. Products manufactured from modified polymers obtained using the process of the present invention can be structurally more efficient and therefore of lower weight due to the resultant improved mechanical properties compared to products manufactured using modified polymers obtained using conventional techniques.

Use of the process of the invention can reduce and even eliminate problems associated with agglomeration of the additive particles due to the steps taken to disperse the additive in the liquid (ie agglomeration of the additive is reduced because in step (I) a substantially homogeneous dispersion of the additive in the liquid is typically obtained).

The present invention also provides a modified polymer obtainable by a process of the invention. More particularly, the present invention provides a modified polymer powder obtainable by the process of the invention.

In one aspect, the present invention provides conductive and semi-conductive polymers (also known as electroactive polymers) obtainable by the process of the invention. These polymers may be used to fabricate products for preventing electromagnetic interference and/or which permit electrostatic discharge. To obtain such polymers, an electrically conductive additive (or an electrically conductive filler) is used in the process of the invention.

In a particular aspect, the present invention provides a modified polymer comprises carbon nanotubes obtainable by the process of the present invention. Such a modified polymer may be used to form an electrically conductive polymer film which may be useful in the fabrication of strain sensors.

Conductive polymer obtained using the process of the present invention can be used to protect electronic components from electromagnetic interference (approx. 10⁻² S/cm) and electrostatic discharge (10⁻⁴ S/cm), since the conductive additive provides a barrier which electromagnetic fields cannot penetrate and prevents the build up of electromagnetic charge. Products fabricated using such conductive polymer may include, but are not limited to, fuel system components which require good static-dissipative properties, seals and gaskets, automotive body panels which can be subjected to electrostatic painting, static-free flooring, children's toys, plastic cards, anti-static packaging, anti-EMI cloths. Such conductive polymers can also be employed as a powder coating.

The present invention also provides a modified polymer obtainable by a process of the invention and comprising a UV absorbing additive, such as titanium dioxide. For example, the present invention provides poly vinyl chloride (PVC) comprising a UV absorbing additive, such as titanium dioxide and a process for making the same. Such a modified polymer could be used in the fabrication of uPVC window frames or door frames, for example, to decrease their susceptibility to UV degradation.

In another aspect, the present invention provides a modified polymer obtainable by a process of the invention and comprising a reversible photochromic additive. For example, the present invention provides a modified poly methyl methacrylate (PMMA) or polycaprolactone (PCL) comprising a reversible photochromic additive and a process for producing the same. The treated polymer could be used in the fabrication of reversible photochromic lenses, which are commonly used in the manufacture of sunglasses.

The present invention also provides an article of manufacture, such as those mentioned above, comprising a modified polymer obtainable by a process of the present invention.

The following non-limiting Examples illustrate the invention.

### EXAMPLE 1

10 g carbon black (CB) was added to 100 g N,N-dimethylformamide (DMF). The mixture was subjected to strong ultrasonic treatment (Fisher Scientific Sonic Dismembrator Model 500, 300 W) for 10 minutes with cooling as necessary.

Additional DMF (200-300 g) was added. High molecular weight polyethylene (HMWPE) powder was added to the CB containing suspension to give a mixture comprising HMWPE and CB at a weight ratio of HMWPE:CB of 99:1. This mixture was heated to 134° C. at 1 atmosphere and maintained at that temperature for 10 minutes with stirring. The mixture was then cooled to 50° C. by air cooling. The DMF was removed using a filter and the recovered HMWPE/CB powder was dried in an oven at 80° C.

### EXAMPLE 2

10 g expanded graphite (EG) was added to 100 g N,N-dimethylformamide (DMF). The mixture was subjected to strong ultrasonic treatment (Fisher Scientific Sonic Dismembrator Model 500, 300 W) for 10 min with cooling as necessary.

Additional DMF (200 to 300 g) was added. High molecular weight polyethylene (HMWPE) powder was added to the EG containing suspension to give a mixture comprising HMWPE and EG at a weight ratio of HMWPE:EG of 95:5. This mixture was heated to 133° C. at 1 atmosphere, and maintained at that temperature for 15 minutes with stirring. The mixture was then cooled to 50° C. by air cooling. The DMF was removed by using a filter and the recovered HMWPE/EG powder was dried in an oven at 80° C.

### EXAMPLE 3

10 g expanded graphite (EG) was added to 100 g toluene. The mixture was subjected to strong ultrasonic treatment (Fisher Scientific Sonic Dismembrator Model 500, 300 W) for 10 minutes with cooling as necessary.

Additional toluene (200 to 300 g) was added. Polyvinyl chloride (PVC) powder was added to the EG containing suspension to give a mixture comprising PVC and EG at a weight ratio of PVC:CB of 95:5 by weight. The mixture was heated to 105° C. at 1 atmosphere and maintained at that temperature for 20 minutes with stirring. The mixture was then cooled to 30° C. by air cooling. The toluene was removed using a filter and recovered PVC/EG powder was dried in an oven at 50° C.

### EXAMPLE 4

10 g carbon black (CB) was added to 100 g toluene. The mixture was subjected to strong ultrasonic treatment (Fisher Scientific Sonic Dismembrator Model 500, 300 W) for 10 min with cooling as necessary.

Additional toluene (200 to 300 g) was added. Polyvinyl chloride (PVC) powder was added to the CB containing suspension to provide a mixture comprising PVC and CB in a weight ratio PVC:CB of 99:1. This mixture was heated to 105° C. at 1 atmosphere and maintained at that temperature for 15 minutes with stirring. The mixture was then cooled to 40° C. by air cooling. The toluene was removed using a filter and the recovered polymer powder was dried in an oven at 50° C.

### EXAMPLE 5

10 g carbon black (CB) was added to 100 g toluene. The mixture was subjected to strong ultrasonic treatment (Fisher Scientific Sonic Dismembrator Model 500, 300 W) for 10 min with cooling as necessary.

Additional toluene (200 to 300 g) was added. Polyvinyl chloride (PVC) powder was added to the CB containing suspension to provide a mixture comprising PVC and CB in a weight ratio PVC:CB of 95:5. The mixture was heated to 106° C. at 1 atmosphere and maintained at that temperature for 15 minutes with stirring. The mixture was then cooled to 40° C. by air cooling. The toluene was removed using a filter and the recovered PVC/CB powder was dried in an oven at 50° C.

### EXAMPLE 6

10 g carbon black (CB) was added to 100 g water. The mixture was subjected to strong ultrasonic treatment (Fisher Scientific Sonic Dismembrator Model 500, 300 W) for 10 min with cooling as necessary.

Additional water (200 to 300 g) was added. Nylon12 powder was added to the CB containing suspension to give a mixture comprising nylon12 and CB in a weight ratio nylon12:CB of 95:5. The mixture was heated to 235° C. at a pressure of about 2 atmospheres and maintained at that temperature and pressure for 20 minutes with stirring. The pressure of the mixture was released and the mixture was then cooled to 50° C. by air cooling. The water was removed using a filter and the recovered nylon12/CB powder was dried in an oven at 100° C.

### EXAMPLE 7

10 g carbon black (CB) was added to 100 g N,N-dimethylformamide (DMF). The mixture was subjected to strong ultrasonic treatment (Fisher Scientific Sonic Dismembrator Model 500, 300 W) for 10 minutes with cooling as necessary.

Additional DMF (200 to 300 g) was added. Extra high molecular weight polyethylene (HMWPE) powder was added to the CB containing suspension to give a mixture comprising HMWPE and CB in a weight ratio of HMWPE:CB of 95:5. The mixture was heated to 140° C. at 1 atmosphere and maintained at this temperature for temperature for 18 minutes with stirring. The mixture was then cooled to 50° C. by air cooling. The DMF was removed using a filter and the recovered HMWPE/CB powder was dried in an oven at 50° C.

### EXAMPLE 8

0.1 g photochromic dye (PD) was added to 100 g water. The mixture was subjected to ultrasonic treatment (Fisher Scientific Sonic Dismembrator Model 500, 300 W) for 2 min with cooling as necessary. The PD dissolved in the water.

Polycaprolactone powder (PCL) was added to the PD containing solution to provide a mixture containing PCL and PD in a weight ratio of PCL:PD of 99.8:0.2. The mixture was heated to 70° C. at 1 atmosphere and maintained at that temperature for 20 minutes with stirring. The water was removed using a filter without cooling and the recovered PCL/PD powder was dried at room temperature.

The recovered powder had photochromic properties under UV light.

### EXAMPLE 9

2 g carbon nanotubes (CNTs) were added to 100 g N,N-dimethylformamide (DMF). The mixture was subjected to strong ultrasonic treatment (Fisher Scientific Sonic Dismembrator Model 500, 300 W) for 10 minutes with cooling as necessary.

Additional DMF (200 to 300 g) was added. High molecular weight polyethylene (HMWPE) powder was added to the CNT suspension to give a mixture comprising HMWPE and CNT in a weight ratio of HMWPE:CNT of 99:1. The mixture was heated to 133° C. at 1 atmosphere and maintained at that temperature for 10 minutes with stirring. The mixture was then cooled to 50° C. by air cooling. The DMF was removed using a filter and the recovered HMWPE/CNT powder dried in an oven at 50° C.

### EXAMPLE 10

3 g TITANIUM DIOXIDE (TiO₂) with 40 nm of diameter were added to 100 g N,N-dimethylformamide (DMF). The mixture was subjected to strong ultrasonic treatment (Fisher Scientific Sonic Dismembrator Model 500, 300 W) for 10 minutes with cooling as necessary.

Additional DMF (200 to 300 g) was added. High molecular weight polyethylene (HMWPE) powder was added to the TiO₂ suspension to give a mixture comprising HMWPE and TiO₂ in a weight ration of HMWPE:TiO₂ of 98:2. The mixture was heated to 132° C. at 1 atmosphere and maintained at that temperature for 15 minutes with stirring. The mixture was then cooled to 50° C. by air cooling. The DMF was removed using a filter and the recovered HMWPE/TiO₂ powder dried in an oven at 50° C. HMWPE powder coated by TiO₂ nanoparticles was confirmed by scanning electronic microscopy.

### Testing

To test the electrical conductivity properties of powders produced in the above Examples compression molded samples of the powders were produced.

### Preparation of Compression Molded Samples

The powder was placed in a mould and subjected to heat and pressure using a 20 Ton Lab Press (Modular, Manchester, UK, www.ibt-eng.com). The temperature used depended on the nature of the modified polymer. Modified polymers containing HMWPE were heated to about 160° C. for 5 minutes; modified polymers containing PVC were heated to about 160° C. for 4 minutes and modified polymers containing nylon were heated to about 210° C. for 5 minutes.

### Conductivity Testing

The conductivity of the compression molded samples having a surface of 4.5 cm×8.5 cm×0.15 cm was measured using a standard four-point method at room temperature. The results are shown in Table 1 below.

TABLE 1

| Example | Conductivity (S/cm) |
|---|---|
| 1 | 10⁻⁴ |
| 2 | 10⁻³ |
| 3 | 10⁻³ |
| 4 | 10⁻⁴ |
| 5 | 10⁻² |
| 6 | 10⁻² |
| 7 | 10⁻² |
| 9 | 10⁻¹ |

What is claimed:

1. A process for producing a treated or modified polymer, which process comprises the steps of:
(I) providing a mixture comprising a liquid, an additive and a polymer, wherein the additive is dispersed in the liquid; and
(H) heating the mixture obtained in step (I) to soften the surface of the polymer so that the additive attaches to the polymer.

2. (canceled)

3. (canceled)

4. A process according to claim 1, wherein the polymer is in the faun of a powder or pellets.

5. (canceled)

6. (canceled)

7. A process according to claim 1, wherein the additive is insoluble in the liquid.

8. A process according to claim 1, wherein the additive is a photochromic additive, an anti-UV degradation additive or an electrically conductive additive.

9. A process according to claim 1, wherein the liquid is selected from water, toluene, N,N-dimethylformamide and chloroform.

10. A process according to claim 1, wherein dispersion of the additive in the liquid is conducted using ultrasonic dispersion.

11. A process according to claim 1, wherein the polymer is selected from nylons, polyethylenes, poly(vinyl chloride)s, polycaprolactones, poly methyl methacrylates, styrene-vinyl acetate diblock copolymers, polypropylenes and blends thereof.

12. (canceled)

13. A process according to claim 1, wherein the weight ratio of the polymer to the additive is from about 85:15 to about 99:1.

14. A process according to claim 1, wherein in step (II) the mixture is heated to a temperature from about 0.1 to about 10° C. below the melting point of the polymer.

15. (canceled)

16. A process according to claim 1, wherein step (II) is carried out for a time period of from about 2 to about 60 minutes.

17. A process according to claim 1, which additionally comprises the step of cooling the mixture after step (II).

18. (canceled)

19. A modified polymer obtainable by a process as defined in claim 1.

20. A polymer according to claim 19, which is conductive or semi-conductive.

21. A polymer according to claim 19, wherein the additive comprises carbon black, carbon nanotubes or expanded graphite.

22. A polymer according to claim 19, comprising a polyethylene, a polyvinyl chloride or a nylon.

23. A polymer according to claim 19, comprising an anti-UV degradation additive.

24. A polymer according to claim 23, comprising at least one of titanium dioxide and polyvinyl chloride.

25. A polymer according to claim 19, comprising a reversible photochromic additive.

26. A polymer according to claim 25, comprising polymethyl methacrylate or polycaprolactone.

27. An article of manufacture comprising a polymer obtainable by a process as defined in claim 1.

28. (canceled)

29. (canceled)

30. A process according to claim 7, wherein the additive is selected from carbon black, graphite, expanded graphite, graphite oxide, short carbon fibers, boron fibers, carbon nanotubes, metal particles, TiO2, MgO2, short glass fibres, mineral fillers, ceramic particles or fibres, natural montmorillonite, clays and combinations thereof.
